(19) United States
(12) Patent Application Publication
(10) Pub. No.: US 2024/0191076 A1
(43) Pub. Date: Jun. 13, 2024

(54) Thermoplastic special engineering plastic PPS/PI alloy material and preparation method thereof

(71) Applicant: Qingdao University of Science and Technology, Qingdao, Shandong (CN)

(72) Inventor: Zhaoge HUANG, Qingdao, Shandong (CN)

(21) Appl. No.: 17/790,519

(22) PCT Filed: Nov. 3, 2021
(86) PCT No.: PCT/CN2021/128373

§ 371 Date: Jul. 1, 2022

(30) Foreign Application Priority Data
May 7, 2021 (CN) 202110492487X

(51) Int. Cl. C08L 81/02

(52) U.S. Cl. CPC C08L 81/02; C08L 2205/03

(57) ABSTRACT

The present invention belongs to the technical field of synthetic materials, specifically a thermoplastic special engineering plastic PPS/PI alloy material and preparation method thereof, ingredients of the alloy material include: PPS 75-85 parts, PI 10-20 part, activated alumina 10-15 parts, polyfluortetraethylene 0.2-0.5 part; the activated alumina is prepared with aluminum oxide and epoxy-containing silane coupling agents; a preparation method of the alloy material is: mixing the PPS, the PI, the activated alumina and the polyfluortetraethylene at an atmospheric temperature high-speed mixer, extruding and pelletizing the same with a twin-screw extruder and the thermoplastic special engineering plastic PPS/PI alloy material can be obtained. The alloy material has improved wear resistance performance, good high temperature resistance properties, can be used repeatedly and is a kind of environmental-friendly material.

### TECHNICAL FIELD

The present invention belongs to the technical field of synthetic materials, specifically a thermoplastic special engineering plastic PPS/PI alloy material and preparation method thereof.

### BACKGROUND TECHNOLOGY

Special engineering plastics are always of good heat resistance, chemical medium resistance, high strength and good dimensional stability. Among special engineering plastics, polyphenylene sulfide (PPS) is a semi-crystalline thermoplastic material with good comprehensive performance, also a kind of special engineering plastic, and is called “the sixth biggest engineering plastic”, PPS is also called abroad to be high-performance plastic and super engineering plastic. Alternate and unified arrangements of sulfur atoms and benzene rings on diphenylene sulfide chains have partially overlapped x electrons and stable conjugated structures are formed, so that PPS has a high molecular stability to thermal degradation reactions and chemical reactions; the benzene rings are rigid functional groups, as a result, the polyphenylene sulfide material exhibits high rigidity in overall performance, thioether bonds are flexible functional groups and render appropriate flexibility to the polyphenylene sulfide, therefore, the polyphenylene sulfide possesses not only general properties of common engineering plastics, but also have some unique features other than engineering plastics, for example, good heat resistance, chemical resistance, good melting fluidity, electrical properties and high dimensional stability.

Polyimide (PI) is a kind of polymer material with imide structures on main chains of molecules. Due to existence of the imide structures, excellent thermal properties, electrical properties, mechanical properties and radiation resistance properties are given to polyimide; however, as viscosity of the fused mass is high, it is difficult to process the polyimide. Plastic alloy is a new kind of high-performance, functionalized and special material obtained by physical blending or chemical grafting. Therefore, preparation of a PPS/PI alloy can compensate deficiencies of each other and improve application fields. Special engineering plastics are usually used in high temperature and moving parts and shall have good wear resistance properties, thus, it is imperative to prepare a kind of thermoplastic special engineering plastic material with good wear resistance performance and comprehensive mechanical performance.

### SUMMARY OF INVENTION

Targeting at the foregoing problems, the present invention provides a thermoplastic special engineering plastic PPS/PI alloy material and preparation method thereof, the alloy material obtained has good comprehensive mechanical properties and wear resistance properties, and is in the meanwhile a thermoplastic special engineering plastic, which can be used repeatedly and is an environmental-friendly material.

Technical solutions of the present invention are as following:
A thermoplastic special engineering plastic PPS/PI alloy material, calculated in part by weight, ingredients thereof comprise: PPS 75-85 parts, PI 10-20 parts, activated alumina 10-15 parts, and polyfluortetraethylene 0.2-0.5 part; the activated alumina is prepared by aluminum oxide and epoxy-containing silane coupling agents;
Preferably, the epoxy-containing silane coupling agents are KH550.

Preferably, a grain size of the aluminum oxide is 2.5 μm, when the grain size of the aluminum oxide is too big, adhesion to polymers is poor and when the grain size is too small, surface activity is high, dispersion thereof will be difficult and consequently mechanical properties of the alloy material are not good. Preferably, a preparation method of the activated alumina is: weighing the aluminum oxide and the epoxy-containing silane coupling agents at a proportion of 100:1-100:3, activating at a high-speed mixer 90-105° C. for 10-15 minutes and the activated alumina is obtained.

Preferably, in the preparation method for the activated alumina, a rotation velocity of the high-speed mixer is 2500-3500 rpm.

A preparation method of the thermoplastic special engineering plastic PPS/PI alloy material, comprises the following steps:

Weighing PPS, PI, activated alumina and polyfluortetraethylene as per the formula, mixing 10-15 minutes in a high-speed mixer at atmospheric temperature, extruding and pelletizing by a twin-screw extruder, and the thermoplastic special engineering plastic PPS/PI alloy material is obtained. Preferably, during preparation of the thermoplastic special engineering plastic PPS/PI alloy material, a rotation velocity of the high speed mixer is 700-1000 rpm.

Preferably, the twin-screw extruder is a parallel twin-screw extruder, a slenderness ratio of screws is 40:1˜ 44:1, and by use of the twin-screw extruder with the slenderness ratio of the screws 40:1˜ 44:1, perfect mixing of the PPS/PI alloy can be realized, when the slenderness ratio is small, mixing may not be complete, otherwise excess shearing can result in performance deterioration. Preferably, temperatures of sections of the parallel twin-screw extruder are controlled to be in a range of 330° C.˜ 360 ºC, by controlling the temperatures to be in a range of 330° C.˜ 360° C. fusion can be complete, when the temperatures are too low, PI ingredients in the alloy may not be fused fully and when the temperatures are too high, degradation may occur and performance can be deteriorated.

Preferably, a rotation speed of the screws is controlled to be in a range of 90 rpm˜ 150 rpm, when the rotation speed is too low, shearing force is not sufficient to promise full mixing between PPS/PI, otherwise, chain breakage of molecular chains may occur and performance of the alloy material may be deteriorated. In the present invention, activated alumina is obtained after surface treatment to aluminum oxide, activities at surfaces of particles can be improved, dispersity and compatibility between the activated alumina and PPS/PI can be improved, when the alloy material is subject to foreign forces, the alumina will move along with high molecular chains, thus molecular performance of the alloy material can be enhanced, especially wear resistance performance of the alloy material can be improved greatly; PPS and PI resins in ingredients of the present invention are thermoplastic special engineering plastics and are used as primary materials, there are imide rings in main chains of PI molecules, temperature resistance performance and mechanical performance are better than that of PPS, dissolubility parameters and specific inductive capacities of PPS and PI are close, good compatibility can be achieved and PPS/PI alloy material can have better comprehensive properties; the aluminum oxide and polyfluortetraethylene play wear resistance roles, the epoxy-containing silane coupling agents work to improve combination forces among the aluminum oxide, polyfluortetraethylene and PPS/PI; and the foregoing ingredients in the present invention influence each other and work synergically and the alloy material obtained have good comprehensive mechanical performance and wear resistance performance. Preferably, in the present invention, PPS grade 1130C by Zhejiang NHU Co., Ltd.; PI grade 2300 by Saudi Basic Industries Corporation; aluminum oxide, 2.5 μm by Shanghai Ece Detecting Instruments Co., Ltd.; epoxy-containing silane coupling agents grade 560 by Hubei Bluesky New Material Inc. and polyfluortetraethylene by Daikin Industries, Ltd. are selected.

The alloy material prepared in the present invention has a volume loss as low as 0.0055 cm³, elongation strength 70.6 MPa, bending strength 122 MPa, unnotched izod pendulum impact strength 33 KJ/m², heat deformation temperature at 1.8 MPa 228° C.; the PPS/PI alloy material prepared in the present invention is characterized by being high temperature resistant, can be used in 200° ° C. environments, has good comprehensive mechanical properties and wear resistance properties, is in the meantime is thermoplastic special engineering plastic, can be used repeatedly and is an environmental-friendly material.

### EMBODIMENTS

Hereinafter technical solutions in embodiments of the present invention will be described clearly and completely, apparently, the embodiments described herein are only some embodiments of the present invention rather than all. Based on the embodiments in the present invention, all other embodiments obtained by those of ordinary skill in the art without making creative effort shall fall within the protection scope of the present invention.

In the following embodiments, PPS grade 1130C by Zhejiang NHU Co., Ltd.; PI grade 2300 by Saudi Basic Industries Corporation; aluminum oxide, 2.5 μm by Shanghai Ece Detecting Instruments Co., Ltd.; epoxy-containing silane coupling agents grade 560 by Hubei Bluesky New Material Inc. and polyfluortetraethylene by Daikin Industries, Ltd. are used.

### Embodiment 1

A thermoplastic special engineering plastic PPS/PI alloy material and preparation method thereof:
Ingredients: PPS 85 parts, PI 15 parts, activated alumina 10 part and polyfluortetraethylene 0.3 part;
Wherein, preparation of the activated alumina: weighing aluminum oxide and epoxy-containing silane coupling agents as per a mass proportion of 100:1, and mixing for 15 minutes in a high-speed mixer at 100° C. and a mixing rate of 2500 rpm;

Preparation of the PPS/PI wear resistant special engineering plastic alloy: weighing the ingredients as per the formula (rotation speed 700 rpm), mixing evenly, extruding and pelletizing in a parallel twin-screw extruder with a slenderness ratio of 40:1, temperatures of sections of the extruders are section 1 330° C., section 2 340° C., section 3 350° C., section 4 360 ºC, extrusion head 355° C. and the rotation speed of the screws 120 rpm;

Volume loss of the alloy material is 0.0122 cm³, elongation strength 69.1 MPa, bending strength 119 MPa, unnotched izod pendulum impact strength 29 KJ/m², and heat deformation temperature at 1.8 MPa 216° C.

### Embodiment 2

A thermoplastic special engineering plastic PPS/PI alloy material and preparation method thereof:
Ingredients: PPS 80 parts, PI 20 parts, activated alumina 10 parts, and polyfluortetraethylene 0.3 part. Preparation of the activated alumina: weighing aluminum oxide and epoxy-containing silane coupling agents at a proportion of 100:1, and mixing for 15 minutes in a high-speed mixer at 100° C. and a rotation speed of 2500 rpm.

Preparation of PPS/PI wear resistant special engineering plastic alloy: weighing the ingredients as per the formula, mixing evenly the ingredients in an atmospheric temperature high-speed mixer (rotation velocity 850 rpm), extruding and pelletizing in a parallel twin-screw extruder with a slenderness ratio of 40:1, and temperatures of sections of the extruder are section 1 335° C., section 2 345° C., section 3 355° C., section 4 360 ºC, and extrusion head 360° C. A rotation velocity of the screws is 120 rpm.

Volume loss of the alloy material is 0.0093 cm³, elongation strength 70.6 MPa, bending strength 122 MPa, unnotched izod pendulum impact strength 33 KJ/m², and heat deformation temperature at 1.8 MPa is 228° C.

### Embodiment 3

A thermoplastic special engineering plastic PPS/PI alloy material and preparation method thereof:
Ingredients: PPS 85 parts, PI 15 parts, activated alumina 15 parts, and polyfluortetraethylene 0.2 part. Preparation of the activated alumina: weighing aluminum oxide and epoxy-containing silane coupling agents at a proportion of 100:1, and mixing for 15 minutes in a high-speed mixer at 100° C. and 2500 rpm. Preparation of the PPS/PI wear resistant special engineering plastic alloy: weighing the ingredients at the foregoing formula, mixing evenly in an atmospheric temperature high-speed mixer (rotation speed 1000 rpm), extruding and pelletizing at a parallel twin-screw extruder with a slenderness ratio of 40:1 and temperatures of sections of the extruder are section 1 330° C., section 2 340° C., section 3 350° C., section 4 360 ºC and extrusion head 355° C. A rotation speed of the screws is 120 rpm;

Volume loss of the alloy material is 0.0055 cm³, elongation strength 68.0 MPa, bending strength 113 MPa, unnotched izod pendulum impact strength 27 KJ/m², and a heat deformation temperature at 1.8 MPa is 220° C.

### Comparative Example 1

A PPS/PI alloy material and preparation method thereof: Ingredients: PPS 85 parts and PI 15 parts;
Preparation method: weighing the ingredients as per the formula, mixing evenly, extruding and pelletizing with a parallel twin-screw extruder with a slenderness ratio 40:1, and temperatures in sections of the extruder are section 1 330° C., section 2 340° C., section 3 350° C., section 4 360° C., and extrusion head 355° C. A rotation speed of the screws is 120 rpm.

Volume loss of the alloy material is 0.0851 cm³, elongation strength 71.5 MPa, bending strength 120 MPa, unnotched izod pendulum impact strength 35 KJ/m² and heat deformation temperature at 1.8 MPa is 212° C.

### Comparative Example 2

Volume loss of PPS/PA66 alloy materials commercially available is 0.1722 cm³, elongation strength 58.5 MPa, bending strength 115 MPa, unnotched izod pendulum impact strength 15 kJ/m², and heat deformation temperature at 1.8 MPa is 178° C.

### Comparative Example 3

Volume loss of PPS/PES alloy materials commercially available is 0.1455 cm³, elongation strength 66.5 MPa, bending strength 108 MPa, unnotched izod pendulum impact strength 7.8 KJ/m², and heat deformation temperature at 1.8 MPa is 195° C.

When comparing the alloy materials prepared in the embodiments of the present invention and the alloy material obtained in comparative example 1, volume losses of the alloy materials prepared in the embodiments are only ⅛ of that of the comparative example, and the alloy materials prepared in the present invention are obviously more wear resistant compared with the comparative examples 1-3.

For the alloy material prepared in the present invention, the volume loss is reduced to 0.0059 cm³, elongation strength 68.9 MPa, bending strength 117 MPa, unnotched izod pendulum impact strength as high as 27 kJ/m², and heat deformation temperature at 1.8 MPa is 217° C.; the PPS/PI alloy material prepared in the present invention is characterized by being highly temperature resistant, can be used in 200° ° C. high temperature environments, has good comprehensive mechanical properties and wear resistant properties, and is in the meanwhile a thermoplastic special engineering plastic, can be used repeatedly and is a kind of environmental-friendly material.

1. A thermoplastic special engineering plastic PPS/PI alloy material, calculated in part by weight, ingredients thereof comprise: PPS 75-85 parts, PI 10-20 parts, activated alumina 10-15 parts, and polyfluortetraethylene 0.2-0.5 part;
the activated alumina is prepared by aluminum oxide and epoxy-containing silane coupling agents;

2. The thermoplastic special engineering plastic PPS/PI alloy material according to claim 1, wherein a preparation method of the activated alumina is: weighing the aluminum oxide and the epoxy-containing silane coupling agents at a proportion of 100:1-100:3, activating at a high-speed mixer 90-105° C. for 10-15 minutes and the activated alumina is obtained.

3. The thermoplastic special engineering plastic PPS/PI alloy material according to claim 1, wherein in the preparation method for the activated alumina, a rotation velocity of the high-speed mixer is 2500-3500 rpm.

4. A preparation method of the thermoplastic special engineering plastic PPS/PI alloy material as defined in claim 1, comprises the following steps:
weighing PPS, PI, activated alumina and polyfluortetraethylene as per the formula, mixing 10-15 minutes in a high-speed mixer at atmospheric temperature, extruding and pelletizing by a twin-screw extruder, and the thermoplastic special engineering plastic PPS/PI alloy material is obtained.

5. The preparation method of the thermoplastic special engineering plastic PPS/PI alloy material according to claim 4, wherein during preparation of the thermoplastic special engineering plastic PPS/PI alloy material, a rotation velocity of the high speed mixer is 700-1000 rpm.

6. The preparation method of the thermoplastic special engineering plastic PPS/PI alloy material according to claim 4, wherein the twin-screw extruder is a parallel twin-screw extruder, a slenderness ratio of screws is 40:1˜ 44:1.

7. The preparation method of the thermoplastic special engineering plastic PPS/PI alloy material according to claim 6, wherein temperatures of sections of the parallel twin-screw extruder are controlled to be in a range of 330° C.˜ 360° C.

8. The preparation method of the thermoplastic special engineering plastic PPS/PI alloy material according to claim 6, wherein a rotation speed of the screws is controlled to be in a range of 90 rpm˜ 150 rpm.
